(19) United States
(12) Patent Application Publication
(10) Pub. No.: US 2026/0025421 A1
(43) Pub. Date: Jan. 22, 2026

(54) USER EQUIPMENT AUTO-DIALED EMERGENCY CALL MANAGEMENT

(71) Applicant: T-Mobile USA, Inc., Bellevue, WA (US)

(72) Inventor: Hang Hoi Yau, Sammamish, WA (US)

(21) Appl. No.: 18/778,586

(22) Filed: Jul. 19, 2024

(51) Int. Cl. H04L 65/1104; H04L 65/1096; H04W 4/90

(52) U.S. Cl. CPC H04L 65/1104; H04L 65/1096; H04W 4/90

(57) ABSTRACT

Techniques, devices, and systems for user equipment (UE) auto-dialed emergency call management are discussed herein. For example, UEs, which may be communicatively connected to wireless networks, may transmit communications associated with emergencies that include session initiation protocol (SIP) messages with subservice fields. The subservice fields can be utilized to indicate to PSAPs, to which the wireless networks route the SIP messages with the subservice fields, that the SIP messages are associated with UE auto-dialed calls.

### BACKGROUND

In telecommunications, networks utilized to enable wireless and wireline devices to access internet protocol (IP) multimedia, messaging, and voice applications, and services include emergency call services. The emergency call services support the increasingly mobile nature of modern communications connect user equipment (UEs) to the appropriate emergency services regardless of their location. Communications such as emergency calls placed by the UEs are diverted to public-safety access points (PSAPs) to be processed by the PSAPs. The PSAPs, which are connected to public switched telephone network (PSTNs) and/or IP networks, have operators at physical locations that receive the emergency calls and route the calls to appropriate emergency services agencies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 schematically illustrates an example environment having a PSAP that receives information enabling the PSAP to know whether an emergency call associated with a message that is received was auto-dialed by a UE, according to implementations of the present disclosure.

FIG. 2 shows an example call flow illustrating user equipment auto-dialed call management for transmitting subservice fields with SIM messages corresponding to emergency calls.

FIG. 3 shows an example call flow illustrating user equipment auto-dialed call management for transmitting different types of subservice fields with SIM messages corresponding to emergency calls associated with different numbers.

FIG. 4 illustrates an example process for providing information enabling a PSAP to know whether an emergency call that is received includes a UE-identified auto-dialed emergency call.

FIG. 5 illustrates is a block diagram of a server computer architecture, in accordance with some examples of the present disclosure.

### DETAILED DESCRIPTION

The systems, devices, and techniques described herein can be implemented in a number of ways. References are made to the accompanying drawings that form a part hereof, and in which are shown by way of illustration specific configurations or examples, in which like numerals represent like elements throughout the several figures.

Techniques described herein are directed to providing improved routing of emergency communications with information related to auto-dialed calls by UEs for emergency response purposes. For example, the UEs, which may be communicatively connected to wireless networks, may transmit communications associated with emergencies that include session initiation protocol (SIP) messages with subservice fields. The subservice fields can be utilized to indicate to PSAPs, to which the wireless networks route the SIP messages with the subservice fields, that the SIP messages are associated with UE auto-dialed calls.

In various implementations, the UEs can place the auto-dialed calls and convert the calls to the SIP messages, such as SOS INVITE messages, with the subservice fields. The auto-dialed calls can be placed by the UEs in response to the UEs detecting emergencies associated with the users. The subservice fields being transmitted to, and received by the PSAPs, can be utilized by the PSAPs to distinguish the SIP messages as being associated with the auto-dialed calls instead of manually user-dialed calls. In other examples, the UEs can place, by default, the auto-dialed calls by dialing a primary emergency number (e.g., 911) (e.g., placing a 911 call). In other examples, the UEs can place the auto-dialed calls by dialing other numbers (e.g., placing an other emergency number call) based on previous attach accept or registration accept messages being communicated by the wireless networks.

Accordingly, the techniques, devices, and systems described herein improve the service quality of telecommunication networks, including 5G networks, 4G networks (long term evolution-advanced (LTE-A) networks, long term evolution (LTE) networks, etc.), and/or networks of other kinds. In contrast to existing UEs and wireless networks that do not utilize the subservice fields, the UEs and wireless networks being operated according to the techniques discussed herein and utilizing the subservice fields to identify that the SIM messages are associated with the UE auto-dialed calls may conserve network resources. By utilizing the subservice fields, the PSAPs associated with the wireless networks being operated according to the techniques discussed herein may quickly and efficiently identify that the SIM messages were generated by the UEs originating the calls. The PSAPs associated with the wireless networks being operated according to the techniques discussed herein may utilize the subservice fields to route the SIM messages associated with the UE auto-dialed calls more quickly. The PSAPs associated with the wireless networks being operated according to the techniques discussed herein may utilize SIM messages without subservice fields to route the SIM messages associated with manually user-dialed calls more quickly.

The UEs and wireless networks being operated according to the techniques discussed herein can utilize the subservice fields to decrease overall time during which any UEs are consuming network resources. Existing UEs that are required to exchange large numbers of messages and/or larges amount data for emergency calls to be correctly processed by PSAPs that are unable to obtain information regarding whether the emergency calls are placed by UEs automatically or by users manually. In contrast to the existing UEs, the UEs operating according to the techniques herein exchange relatively minimal numbers of messages and relatively minimal amounts of data since the UEs quickly and unambiguously inform the PSAPs of the SIM messages being associated with UE auto-dialed numbers or manually user-dialed numbers.

The UEs and wireless networks being operated according to the techniques discussed herein and utilizing the subservice fields to identify that the SIM messages are associated with the UE auto-dialed calls may conserve compute resources. The UEs operating according to the techniques discussed herein by utilizing the subservice fields can avoid unnecessary processing of messages that may otherwise by required for the UEs operating according to conventional techniques. The UEs operating according to the techniques discussed herein by utilizing the subservice fields can efficiently transmit the SIM messages with the subservice fields and receive subsequent voice and/or data communications based on the PSAPs receiving the subservice fields and utilizing the knowledge of whether the calls were auto-dialed by UEs or manually-dialed by users to respond to the calls efficiently and effectively.

In general, the techniques discussed herein may be implemented in any multi connectivity environment, which is not limited to a 5G environment, a 4G environment, a third generation (3G) environment, a second generation (2G) environment, any other type of environment, or any combination thereof. In some examples, an NR base station can be considered a primary base station, an LTE base station can be considered a secondary base station, and vice versa. In some instances, a core network can be represented as a 5G core network, a 4G core network, any other type of core network, or any combination thereof. In some instances, the techniques can be implemented in standalone implementations (e.g., Option 1 and/or 2, as referred to by 3GPP) or in non-standalone implementations such as those referred to as Option 3, 4, 7, etc. by 3GPP. In some examples, the techniques discussed herein may be implemented outside a dual connectivity environment involving a single base station or network access technology and multiple bearers.

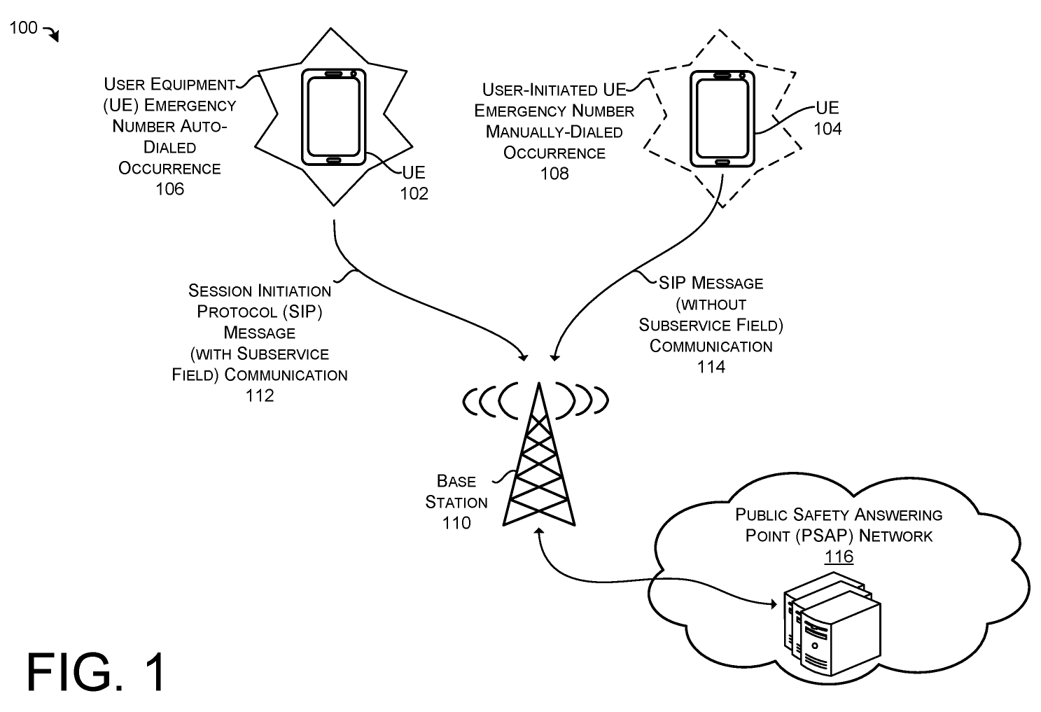

FIG. 1 schematically illustrates an example environment 100 having a PSAP that receives information enabling the PSAP to know whether an emergency call associated with a message that is received was auto-dialed by a UE, according to implementations of the present disclosure. The environment 100 can include one or more UEs. The UEs can include a UE 102 and/or a UE 104 associated with a UE emergency number auto-dialed occurrence 106 and a user-initiated UE emergency number manually-dialed occurrence 108, respectively. The UEs can include one or more other UEs (e.g., one or more UEs placing calls by auto-dialing emergency numbers, one or more UEs placing calls by dialing manually user-initiated emergency numbers, one or more UEs placing any types of calls and/or performing one or more other occurrences, or any combination thereof).

The terms “user equipment (UE),” “user device,” “wireless communication device,” “wireless device,” “communication device,” “mobile device,” and “client device,” can be used interchangeably to describe any UE (e.g., any of the UE(s), such as the UE 102 and/or the UE 104, etc., in the environment 100) that is capable of transmitting/receiving data wirelessly using any suitable wireless communications/data technology, protocol, or standard, such as global system for mobile communications (GSM), time division multiple access (TDMA), universal mobile telecommunications system (UMTS), evolution-data optimized (EVDO), long term evolution (LTE), advanced LTE (LTE+), new radio (NR), generic access network (GAN), unlicensed mobile access (UMA), code division multiple access (CDMA), orthogonal frequency division multiple access (OFDM), general packet radio service (GPRS), enhanced data GSM environment (EDGE), advanced mobile phone system (AMPS), high speed packet access (HSPA), evolved HSPA (HSPA+), voice over IP (VoIP), VoLTE, institute of electrical and electronics engineers’ (IEEE) 802.1x protocols, WiMAX, Wi-Fi, data over cable service interface specification (DOCSIS), digital subscriber line (DSL), CBRS, and/or any future internet protocol (IP)-based network technology or evolution of an existing IP-based network technology.

Examples of UEs (e.g., any of the UE(s), such as the UE 102 and/or the UE 104, etc., in the environment 100) can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over the network. In some instances, one or more devices (e.g., any of the UE(s), such as the UE 102 and/or the UE 104, etc., in the environment 100) can include at least one device supporting one or more of a sensor network, voice services, smart city cameras, gigabytes-in-a-second communications, 3D video, 4K screens, work & play in the cloud, augmented reality, industrial and/or vehicular automation, mission critical broadband, or self-driving cars.

As illustrated, the environment 100 includes one or more base stations, such as a base station 110 in communication with any of the UE(s) (e.g., the UE 102 and/or the UE 104, etc., in the environment 100). In some implementations, the base station 110 may include one or more telecommunications network transceivers (e.g., a 5G transceiver (e.g., a gNodeB), a 4G transceiver (e.g., an eNodeB), etc., or any combination thereof). The base station 110, and/or any of the UE(s), such as the UE 102 and/or the UE 104, etc., in the environment 100, may be capable of supporting any of the communication(s), as discussed below in further detail, which may include 5G radio communications, such as new radio (NR) communications, 4G radio communications, such as LTE radio communications, any other types of communications, or any combination thereof. In some examples, the base station 110 may be configured to support at least one of enhanced mobile broadband (eMBB) communications, ultra reliable low latency communications (URLLCs), or massive machine type communications (mMTCs).

According to various implementations, the base station 110 may communicate with a core network (e.g., a telecommunications core network) (not illustrated) that can include a 5G core network, a 4G core network (e.g., an evolved packet core (EPC)), etc., or any combination thereof. Services may be relayed between the core network(s) and device(s) in the environment 100. In some cases, the core network can provide the services, in turn, to and from at least one wide area network (WAN) (such as the Internet), an internet protocol (IP) media subsystem (IMS) network, and the like. In various implementations, the services can include voice services, data services, and the like.

The base station 110 may be in communication with any of the UE(s), such as the UE 102 and/or the UE 104, etc., in the environment 100, via one or more connections. The connection(s) may be utilized for one or more communications to be exchanged between any of the UE(s), such as the UE 102 and/or the UE 104, etc., in the environment 100, and the base station 110. In some examples, the communication(s) can include one or more SIP message communications. The SIP message communication(s) can include one or more SIP message (with subservice field) communications, such as a SIP message (with subservice field) communication 112. In alternative or additional examples, the SIP message communication(s) can include one or more SIP message (without subservice field) communication, such as a SIP message (without subservice field) communication 114.

The base station can route any of at least one of the communication(s) to one or more PSAPs, which can include, individually or in combination, a PSAP system. For example, the PSAPs, such as a PSAP 116, may include one or more computing devices implemented within one or more systems (or "PSAP systems") of the PSAPs. The PSAP 116 may utilize the computing device(s) to route the communications (e.g., one or more emergency communications) exchanged between any of the UE(s), such as the UE 102 and/or the UE 104, etc., in the environment 100, and the base station 110, to an appropriate entity. The PSAP 116 (e.g., the computing device(s) in the PSAP 116), may include one or more hardware processors configured to execute stored instructions. Such processor(s) may comprise one or more processing cores. Further, the computing device(s) (or "PSAP device(s)") in the PSAP system(s) may include one or more communication interfaces configured to provide communications between the core network via the base station 110.

The PSAP 116 (e.g., the computing device(s) of the PSAP 116) may include computer-readable media that stores various executable components (e.g., software-based components, firmware-based components, etc.). The computer-readable media of the PSAP 116 (e.g., the computing device(s) of the PSAP 116) may store components to implement functionality described herein. It should be appreciated by those skilled in the art that computer-readable storage media may include any available media that provides for the non-transitory storage of data and that can be accessed by the PSAP 116. In some examples, the operations performed by devices as described herein may be supported by one or more devices similar to the computing device(s) of the PSAP 116. Some or all of the operations performed by the PSAP 116 (e.g., the computing device(s) of the PSAP 116) and/or any components included therein, may be performed by any types of computing devices, such as one or more computing devices operating in a cloud-based arrangement.

The computer-readable media may include portions, or components, that configure the PSAP 116 (e.g., the computing device(s) of the PSAP 116) to perform various operations described herein. For example, the computer-readable media of the PSAP 116 may include some combination of components configured to implement the described techniques. In embodiments, the computer-readable media of the PSAP 116 (e.g., the computing device(s) of the PSAP 116) may include one or more modules for routing emergency communications to an appropriate.

In various examples, the PSAP 116 can utilize information received from the UE(s) to identify whether one or more messages, such as one or more SIP messages (e.g., in the communication(s)), are received from one or more UEs associated with one or more UE emergency number auto-dialed occurrences and/or one or more UEs associated with one or more user-initiated UE emergency number manually-dialed occurrences. The PSAP 116 can utilize information received from the UE(s) to identify whether any of the message(s) (e.g., the SIP message(s)) are received from the UE(s), such as the UE 102, associated with the more UE emergency number auto-dialed occurrences(s), such as the UE emergency number auto-dialed occurrence 106. Alternatively or additionally, the PSAP 116 can utilize information received from the UE(s) to identify whether any of the message(s) (e.g., the SIP message(s)) are received from the UE(s), such as the UE 104, associated with the user-initiated UE emergency number manually-dialed occurrence(s), such as the user-initiated UE emergency number manually-dialed occurrence 108.

The information utilized by the PSAP 116 to identify whether the SIP message(s) are received from the UE(s) associated with any of the occurrence(s) 106 and/or 108 can include information indicating whether one or more subservice fields are received along with the SIP message(s). The information indicating whether the subservice field(s) are received along with the SIP message(s) can be generated by the PSAP 116 based on the SIP message(s), and possibly the subservice field(s), received from the UE(s).

In some examples, the information utilized by the PSAP 116 to identify that a SIP message is received from the UE 102 associated with the UE emergency number auto-dialed occurrence 106 can include information indicating that a subservice field is received along with the SIP message. In those or other examples, the information utilized by the PSAP 116 to identify that a SIP message is received from the UE 104 associated with the user-initiated UE emergency number manually-dialed occurrence 108 can include information indicating that a subservice field is not received along with the SIP message.

The PSAP 116 can receive the SIP message (with subservice field) communication 112 and the SIP message (without subservice field) communication 114, and distinguish between the SIP message (with subservice field) communication 112 and the SIP message (without subservice field) communication 114. The PSAP 116 can distinguish between the SIP message (with subservice field) communication 112 and the SIP message (without subservice field) communication 114 by receiving the SIP message (with subservice field) communication 112 and identifying the subservice field as being included with the SIP message (with subservice field) communication 112. Alternatively or additionally, the PSAP 116 can distinguish between the SIP message (with subservice field) communication 112 and the SIP message (without subservice field) communication 114 by receiving the SIP message (without subservice field) communication 114 and identifying that no subservice field is included with the SIP message (without subservice field) communication 114.

The PSAP 116 can distinguish between whether auto-dialing or user-dialing initiated an SIP message received by the PSAP 116. The PSAP 116 can distinguish between whether auto-dialing or user-dialing initiated the received SIP message by receiving, as the received SIP message, the SIP message (with subservice field) communication 112 and identifying the subservice field being received with the SIP message (with subservice field) communication 112. Alternatively or additionally, the PSAP 116 can distinguish between whether auto-dialing or user-dialing initiated the received SIP message by receiving, as the received SIP message, the SIP message (without subservice field) communication 114 and identifying that no subservice field is received with SIP message (without subservice field) communication 114.

In alternative or additionally examples, the information utilized by the PSAP 116 to identify whether the SIP message(s) are received from the UE(s) associated with any of the occurrence(s) 106 and/or 108 can include information indicating one or more types of one or more subservice fields received along with the SIP message(s). The information indicating the type(s) of the subservice field(s) can be generated by the PSAP 116 based on the SIP message(s), and possibly the subservice field(s), received from the UE(s).

In some examples, the information utilized by the PSAP 116, which can identify that a SIP message is received from the UE 102 associated with the UE emergency number auto-dialed occurrence 106, can include information identifying a specific type of the UE 102. In various cases, the information utilized by the PSAP 116 can include information corresponding to a type of subservice field received along with the SIP message includes a device-related type of subservice field. The device-related type of subservice field may include a smart phone type of subservice field, a smart wearable device type of subservice field (e.g., a smart watch type of subservice field), a vehicle type of subservice field, or another type of subservice field.

The type(s) of subservice field can be generated by the UE(s) associated with different types (e.g., values) of emergency numbers being auto-dialed by the UE(s). For example, a type of subservice field generated by the UE(s), such as the UE 102, can include the smart phone type of subservice field, the smart wearable device type of subservice field (e.g., the smart watch type of subservice field), the vehicle type of subservice field, or another type of subservice field, based on a type (e.g., a value) of an emergency number auto-dialed by the UE 102. In such an example or another example, the type of subservice field can include the smart phone type of subservice field, the smart wearable device type of subservice field (e.g., the smart watch type of subservice field), the vehicle type of subservice field, or another type of subservice field, corresponding to the emergency number auto-dialed by the UE 102 having a value associated with an emergency number being auto-dialed by a smart phone, a value associated with an emergency number being auto-dialed by a smart wearable device (e.g., a smart watch), a value associated with an emergency number being auto-dialed by a vehicle, a value associated with an emergency number being auto-dialed by a smart phone, respectively, etc.

The subservice field can have a value, format, etc., indicating the type of the subservice field. For example, the subservice field received along with the SIP message and having a value of autotriggerbysmartphone may indicate the SIP message was generated based on a smart phone emergency number auto-dialed occurrence. The SIP message and having the value of autotriggerbysmartphone may correspond to the value associated with the emergency number being auto-dialed by the smart phone.

In another example, the subservice field having the value of autotriggerbywatch may indicate the SIP message was generated based on a watch emergency number auto-dialed occurrence. The SIP message and having the value of autotriggerbywatch may correspond to the value associated with the emergency number being auto-dialed by the watch.

In another example, the subservice field having the value of auttriggerbyvehicle may indicate the SIP message was generated based on a vehicle emergency number auto-dialed occurrence. The SIP message and having the value of auttriggerbyvehicle may correspond to the value associated with the emergency number being auto-dialed by the vehicle.

In another example, the subservice field having another value may indicate the SIP message was generated based on another device emergency number auto-dialed occurrence. The SIP message and having the other value may correspond to the value associated with the emergency number being auto-dialed by a specific type of the other device. The SIP message and having the other value may correspond to the value associated with the emergency number being auto-dialed by the other device, which may be of a different type.

In various cases, one or more of the SIM message(s) can be transmitted (or "sent") by the UE(s), such as the UE 102, by detecting one or more triggering events; and, in response to the detecting of the triggering event(s), placing one or more auto-dialed emergency calls (e.g., placing one or more auto-dialed primary emergency number (e.g., 911) calls, placing one or more other auto-dialed emergency number calls, etc., or any combination thereof).

The triggering event(s) may include one or more of various types triggering events. In some examples, any of the triggering event(s) can be detected by data generated via one or more sensors of the UE(s), such as the UE 102, placing the audio-dialed emergency call(s). The sensor(s) can include one or more accelerometers, one or more microphones, one or more temperature sensors, one or more proximity sensors, one or more gyroscopes, one or more ambient light sensors, one or more magnetometers, one or more fingerprints, one or more barometers, one or more environmental sensors, and so on, or any combination thereof.

The triggering event(s) can be identified based on the UE 102 identifying one or more parameters in the data (e.g., the sensor generated data) associated with one or more characteristics, respectively, falling below or exceeding one or more thresholds. For instance, a triggering event can be identified based on the UE 102 identifying a parameter in the data (e.g., the sensor generated data) associated with a characteristic falls below or exceeds a threshold. By way of example, by utilizing the sensor data, the UE(s), such as the UE 102, can identify whether one or more characteristics associated with one or more users of the UE(s) includes one or more emergency-related characteristics. The characteristic(s) associated with the user(s) may reflect one or more occurrences (e.g., one or more emergency occurrence) undergone by the user(s), one or more emergency occurrences in which the user(s) are involved, and so on, or any combination thereof.

The UE 102 can identify that a characteristic associated with a user of the UE 102 includes an emergency-related characteristic in various ways. For instance, the UE 102 can utilize a parameter in the sensor data to identify whether the characteristic includes the emergency-related characteristic. In some examples, the sensor data associated with, and/or identifying, the characteristic may be utilized by the UE 102 to identify the characteristic as the emergency-related characteristic based on the parameter in the data falling below or exceeding the threshold.

The characteristic(s) may be identified as being various types of emergency-related characteristics, which can represent potential emergency-related occurrences. For example, individual ones of the characteristic(s) identified by the UE 102 as being the emergency-related characteristic(s) may include a fall, a car crash, an impact (e.g., of an object, etc.), a medical emergency (e.g., a heart problem, such as a heart attack, a cardiac arrest, an angina attack or unstable angina, etc.; a respiratory problem, such as pneumonia, psittacosis, acute asthma, acute severe asthma, mild to moderate asthmatic attacks, acute exacerbation of chronic obstructive pulmonary disease (COPD), respiratory failure, adult respiratory distress, etc.; a brain problem, such as a stroke, a loss of consciousness, a seizure, etc.; one or more other physiological conditions, or any combination thereof), one or more of other types of characteristics, or any combination thereof. For example, the characteristic(s) that may be identified as emergency-related characteristic(s) may include biometric characteristics, such as blood pressure, body temperature, heart rate, blood oxygen level, respiration rate, a electroencephalography (EEG) reading, a gait measurement, other additional biometric characteristics, or any combination thereof.

In some cases, identifying the parameter(s) falling below or exceeding the threshold(s) can include the UE 102, for instance, identifying that any type of parameter (e.g., any type of value) of any type of characteristic, such as an emergency characteristic, falls below or exceeds a threshold (e.g., a threshold parameter). For instance, the UE 102 may identify the parameter (e.g., a length, a suddenness, a force, and/or a severity of the fall; a force, a suddenness, and/or a severity of the car crash and/or the object impact; a severity and/or an urgency of the medical emergency; a severity and/or an urgency of the other physiological condition(s); a severity and/or an urgency of the biometric characteristics; a severity and/or an urgency of the other types of characteristic(s); or any combination thereof) exceeds or falls below the threshold parameter (e.g., a threshold length, a threshold suddenness, a threshold force, and/or a threshold severity of the fall; a threshold force, a threshold suddenness, and/or a threshold severity of the car crash and/or the object impact; a threshold severity and/or a threshold urgency of the medical emergency; a severity threshold and/or a threshold urgency of the other physiological condition(s); a threshold severity and/or a threshold urgency of the biometric characteristics; a threshold severity and/or a threshold urgency of the other types of characteristic(s); or any combination thereof).

The subservice field can flag the PSAP 116 to respond according to one or more predetermined procedures associated with auto-dialed emergency calls being distinguished from manually-dialed emergency calls. The subservice field can be processed as a flag by the PSAP 116 to respond according to the predetermined procedure(s).

The predetermined procedures can include the PSAP 116 performing one or more automated actions of various types. In some examples, the PSAP 116 can output one or more alarms, such as one or more audible alarms, one or more visual alarms, one or more haptic alarms, etc., or any combination thereof.

The automated action(s) can include one or more alerts. For example, the PSAP 116 can output one or more alerts including one or more advisories to one or more users (e.g., one or more operators) associated with the PSAP 116. The advisory(ies) can include text displayed on a screen, a recorded voice output from a speaker, etc., or any combination thereof. The advisory(ies) can notify and/or inform the operator(s) of the SIP message being received in response to the auto-dialing of the emergency call (e.g., by the UE 102). The PSAP 116 can perform various operations utilized by PSAP operators to route the call to the appropriate destination.

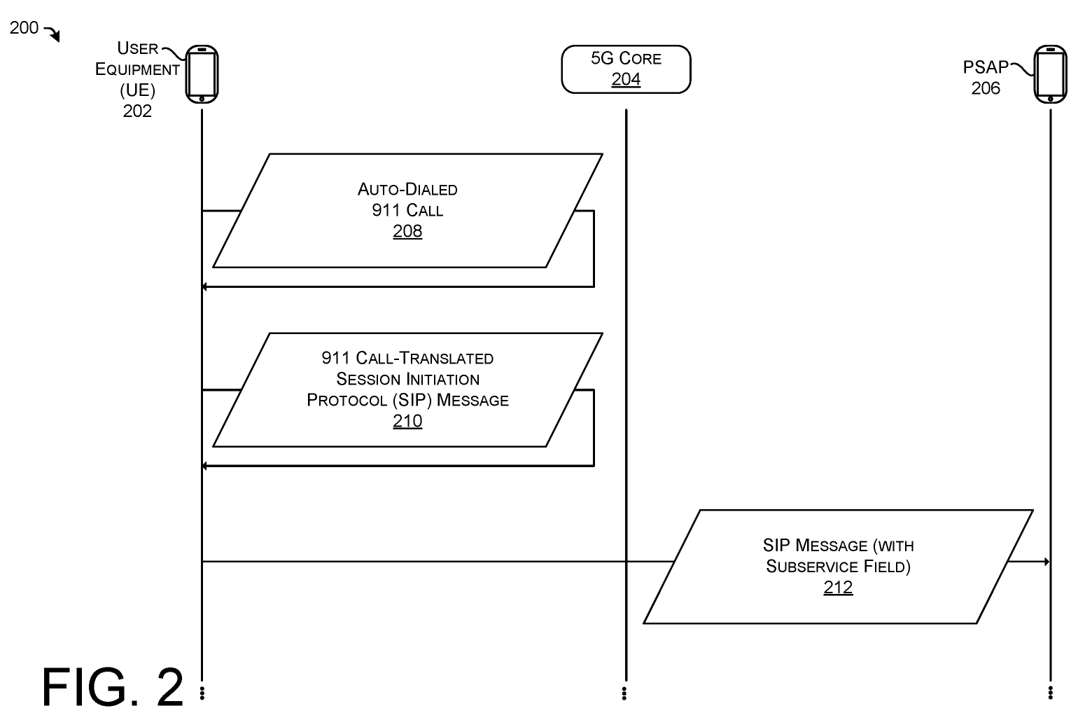

FIG. 2 shows an example call flow 200 illustrating user equipment auto-dialed call management for transmitting subservice fields with SIP messages corresponding to emergency calls. In various cases, a UE 202 may exchange one or more communications (e.g., one or more SIP message communications), via a core (e.g., a 5G core) 204 of a 5G network, and with a PSAP (e.g., one or more PSAP computing devices) 306. In some examples, the UE 202, the core 204, and/or the PSAP 206 may be utilized to implement the UE 102, the 5G core (e.g., with which the base station 110 may communicate), and/or the PSAP 116, respectively, as discussed above with reference to FIG. 1.

The UE 202 may include emergency-oriented code (e.g., logic, such as hard coded logic) utilized by the UE 202 to place the emergency call(s) and/or transmit the SIP message(s) (e.g., one or more communications with the SIP message(s) corresponding to the emergency call(s). The emergency-oriented code may be processed by the UE 202 in response to detecting one or more emergency characteristics, such as the emergency characteristic(s), as discussed above with respect to FIG. 1.

In various cases, the emergency-oriented code may be installed in the UE 202, downloaded by the UE 202, loaded to the UE 202, received by the UE 202, etc., or any combination thereof, prior to the UE 202 placing any emergency calls and/or prior to transmitting any SIP messages corresponding to the emergency calls. For instance, the emergency-oriented code may be installed in the UE 202 prior to a power-on, a startup, and/or an initial configuration, of the UE 202, etc. In some examples, the UE 202 can process the emergency-oriented code (e.g., a portion of the code, such as a partial portion or an entire portion of the code). In those or other examples, the UE 202 can, in response to the processing of the emergency-oriented code, place the emergency call(s) and/or transmit the SIP message(s).

The SIP message(s), which can be transmitted in response to the placing of the emergency call(s), can include one or more SIP message(s) being transmitted with one or more subservice fields. For instance, the UE 202 can detect a parameter associated with an emergency characteristic; and, in response to detecting the parameter is associated with the emergency characteristic based on the parameter falling below or exceeding a threshold, place an emergency call (or " auto-dialed primary emergency number call") (or "auto-dialed 911 call") 208 by dialing a primary emergency number (e.g., 911); translate (e.g., or convert) the emergency call 208 to a SIP message (or "911 call-translated SIP message") 210; and transmit the SIP message 210, as a SIP message (with a subservice field) 212. The UE 202 can transmit the SIP message 212, which can be routed (e.g., forwarded) by the 5G core 204, to the PSAP 206. The subservice field associated with the SIP message 212 may have a value of autotrigger.

In some examples, the UE 202 (e.g., processing the emergency-oriented code) can auto-dial the 911 call 208 and include the subservice field along with the SIP message 212 to indicate the 911 call 208 was auto-dialed. The UE 202, by including the subservice field along with the SIP message 212 being transmitted, can attach the subservice field to the SIP message 212, insert the subservice field into the SIP message 212, link and/or bind the subservice field to the SIP message 212, integrate the subservice field with the SIP message 212, and so on, or any combination thereof.

The PSAP 306 receiving the SIP message 212 can identify the SIP message 212 as being transmitted in response to the placing of the auto-dialed 911 call) 208 and the generating of the 911 call-translated SIP message 210. The PSAP 306 identifying the SIP message 212 as being transmitted in response to the placing of the auto-dialed 911 call 208 and the generating of the 911 call-translated SIP message 210 can respond accordingly. For instance, the PSAP 306 can respond according to predetermined procedures associated with auto-dialed 911 calls being distinguished from manually-dialed 911 calls.

The subservice field can flag the PSAP 306 to respond according to the predetermined procedures. In some examples, the subservice field can be processed as a flag and/or utilized by the PSAP 306 to respond according to the predetermined procedures, as discussed above with reference to FIG. 1.

While the emergency-related code may be installed prior to the initial startup of the UE 202, as discussed above in the current disclosure, it is not limited as such. In alternative examples, the emergency-related code may be installed in the UE 202 at any time (e.g., during or after the initial configuration) with respect to any other types of operations (e.g., after the UE 202 performs various other types of operations).

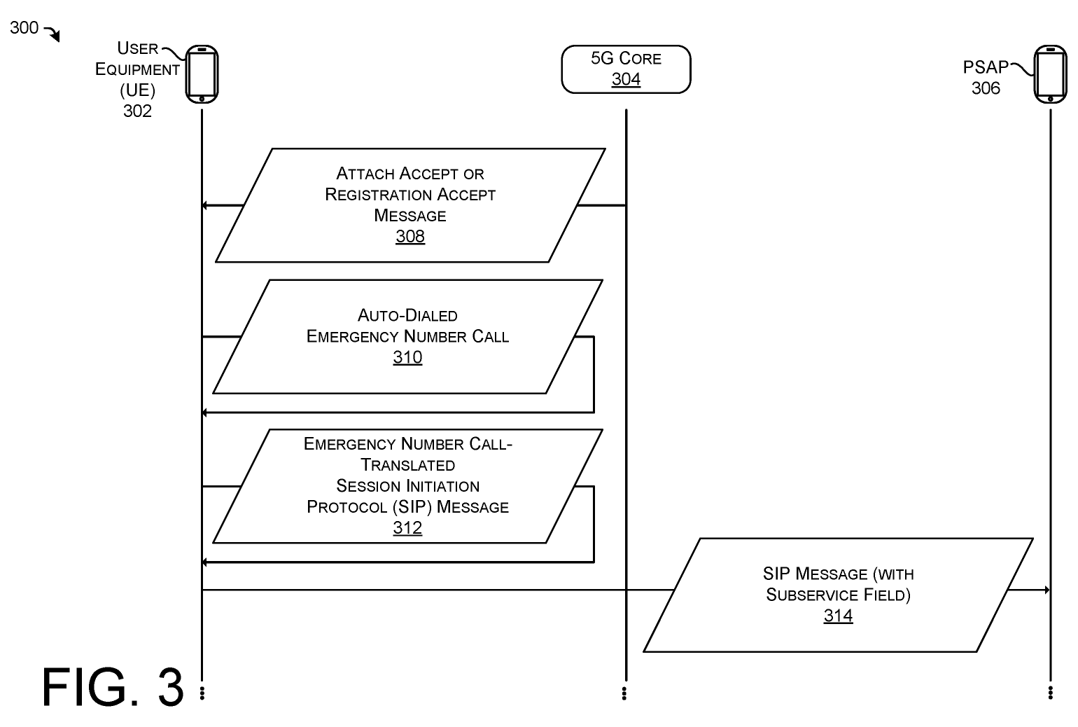

FIG. 3 shows an example call flow 300 illustrating user equipment auto-dialed call management for transmitting different types of subservice fields with SIM messages corresponding to emergency calls associated with different numbers. In various cases, a UE 302 may exchange one or more communications (e.g., one or more SIP message communications), via a core (e.g., a 5G core) 304 of a 5G network, and with a PSAP (e.g., one or more PSAP computing devices) 306. In some examples, the UE 302 may be utilized to implement the UE 102, as discussed above with reference to FIG. 1. In those or other examples, the core 304 may be utilized to implement the 5G core (e.g., with which the base station 110 may communicate) and/or the core 204, as discussed above with reference to FIGS. 1 and 2. In those or other examples, the PSAP 306 may be utilized to implement the PSAP 116 and/or the PSAP 206, as discussed above with reference to FIGS. 1 and 2.

The UE 308 may receive one or more messages from the 5G core 304. In some examples, the message(s) may include one or more SIP messages, such as one or more attach accept messages (e.g., in response to transmitting one or more attach request messages), one or more registration accept messages (e.g., in response to transmitting one or more registration request messages), or any combination thereof. The attach accept message(s) and/or the registration request message(s) may include one or more numbers (e.g., one or more emergency numbers) to be utilized by, and/or code (e.g., logic) to be processed, by the UE 308 in response to detecting one or more parameters associated with one or more emergency characteristics, such as the emergency parameter(s) falling below or exceeding the threshold(s), as discussed above with respect to FIG. 1. For instance, the attach accept message(s) and/or the registration request message(s) may include an extended emergency numbers list (EENL) with the number(s).

In some examples, the UE 308 may receive the message(s) (e.g., the SIP message(s), such as the attach accept message(s) and/or the registration accept message(s)) prior to placing any emergency calls and/or prior to transmitting any SIP messages corresponding to the emergency calls. For instance, the message(s) (e.g., the SIP message(s), such as the attach accept message(s) and/or the registration accept message(s)) may be received by the UE 308 after an initial power-on, an initial startup, and/or an initial configuration, of the UE 308 but before operation of the UE 308, such as before any UE operation associated with any emergency calls and/or any emergency call-related SIP messages.

In various cases, the EENL and/or code received via the attach accept message(s) and/or the registration accept message(s) can be utilized by the UE 308 to respond to auto-dialed emergency calls, and/or instruct the UE 308 how to respond to the auto-dialed emergency calls.

The SIP message(s), which can be transmitted in response to the placing of the emergency call(s), can include one or more SIP message(s) being transmitted with one or more subservice fields. For instance, the UE 308 can detect a parameter associated with an emergency characteristic; and, in response to detecting the parameter is associated with the emergency characteristic based on the parameter falling below or exceeding a threshold, place a call (or "auto-dialed emergency number call") 310 by dialing the emergency number (e.g., 911, 112, 933, 944, etc.,) according to the EENL; translate (e.g., or convert) the call 310 to a SIP message (or "emergency number call-translated SIP message") 312; and transmit the SIP message 312, as a SIP message (with a subservice field) 314. The UE 302 can transmit the SIP message 314, which can be routed (e.g., forwarded) by the 5G core 304, to the PSAP 306. The subservice field associated with the SIP message 314 may have a value of autotrigger.

The primary emergency number (e.g., 911) may include a different type of number than one or more other emergency numbers (e.g., 112, 933, 944, etc.,). The primary emergency number may be accessible and able to be auto-dialed by any of the UE(s) regardless of whether the particular UE includes a subscriber identity module (SIM) card (e.g., a physical SIM card, an e-SIM card, etc., or any combination thereof) that is active or does not include a SIM card (e.g., a physical SIM card, an e-SIM card, etc., or any combination thereof) that is active. The other emergency number(s) may be accessible and able to be auto-dialed by any of the UE(s) only if the particular UE includes the SIM card (e.g., the physical SIM card, the e-SIM card, etc., or any combination thereof) that is active.

In some examples, the primary emergency number (e.g., 911) may be processed by the network providing the connection to any of the UE(s) at a priority above a threshold, based on the particular UE auto-dialing the primary emergency number. In those or other examples, the other emergency number(s) (e.g., 112, 933, 944, etc.,) may be processed by the network providing the connection to any of the UE(s) at a priority at or below a threshold (e.g., the same threshold or a different threshold), based on the particular UE auto-dialing the other emergency number(s).

In some examples, the primary emergency number (e.g., 911) may be auto-dialed by the UE(s) based on different characteristics (e.g., regions, service providers, etc., or any combination thereof) than the other emergency number(s) (e.g., 112, 933, 944, etc.,). For instance, the primary emergency number may be able to be auto-dialed by any of the UE(s) on a national level, based on the particular UE being at any region of the country (e.g., and/or possibly based on the particular UE being at any other region/country). In such an instance or another instance, the other emergency number(s) may be able to be auto-dialed by any of the UE(s) only at a sub-region (e.g., a partial region or an entire region) of the region at which the primary emergency number is able to be auto-dialed by the particular UE.

In some examples, the primary emergency number (e.g., 911) may be able to be auto-dialed by any of the UE(s) regardless of which service provider is utilized to provide the connection between the network and the particular UE. In such an instance or another instance, any of the other emergency number(s) (e.g., 112, 933, 944, etc.,) may be able to be auto-dialed by any of the UE(s) only based on whether the service provider utilized to provide the connection between the network and the particular UE supports calls auto-dialed with the particular other emergency number.

The UE 308 (e.g., utilizing the EENL and/or processing the logic) can auto-dial the emergency number call 310 and include the subservice field along with the SIP message 314 to indicate the emergency number call 310 was auto-dialed. The UE 308, by including the subservice field along with the SIP message 314 being transmitted, can attach the subservice field to the SIP message 314, insert the subservice field into the SIP message 314, link and/or bind the subservice field to the SIP message 314, integrate the subservice field with the SIP message 314, and so on, or any combination thereof.

The PSAP 306 receiving the SIP message 314 can identify the SIP message 314 as being transmitted in response to the placing of the auto-dialed emergency number call (or "auto-dialed EENL-number call") 310 and the generating of the emergency number call-translated SIP message (or "EENL-number call-translated SIP message) 312. The PSAP 306 identifying the emergency number call-translated SIP message 312 as being transmitted, as the SIP message (with a subservice field) 314, in response to the placing of the auto-dialed emergency number call 310 and the generating of the emergency number call-translated SIP message 312 can respond accordingly. For instance, the PSAP 306 can respond according to predetermined procedures associated with auto-dialed emergency number calls being distinguished from manually-dialed emergency number calls.

The subservice field can flag the PSAP 306 to respond according to the predetermined procedures. In some examples, the subservice field can be processed as a flag and/or utilized by the PSAP 306 to respond according to the predetermined procedures (e.g., as discussed above with reference to FIG. 1), and/or at least some different predetermined procedures.

In various cases, the EENL and/or the code received via the attach accept message(s) and/or the registration request message(s) may be utilized to the UE 102 to indicate, to the PSAP 306, a specific type of the UE 102. In some examples, the EENL and/or the code can be utilized by the UE 102 to include the subservice field with the value, format, etc., corresponding to the type of the subservice field, as discussed above with reference to FIG. 1. In those or other examples, the EENL and/or the code can be utilized by the UE 102 to include the subservice field having the value indicating the SIP message was generated by the specific type of the UE 102, as discussed above with reference to FIG. 1.

While the UE 302 may receive the attach accept message(s) and/or the registration request message(s) with the EENL and/or the code, as discussed above in the current disclosure, it is not limited as such. In some examples, the UE 302 may have the code (e.g., the hard coded logic) as in the UE 202, as discussed above with reference to FIG. 2. In those or other examples, the UE 202 may receive the attach accept message(s) and/or the registration request message(s) with the EENL and/or the code. For instance, the UE 202 and/or the UE 302 may include code (e.g., hard coded logic), and/or may receive code via any of the message(s) (e.g., the attach accept message(s) and/or the registration request message(s)), that identifies whether to (e.g., as a default setting) i) use the code (e.g., hard coded logic) to auto-dial emergency calls based on detected parameters associated with emergency characteristics, or ii) whether to use the EENL and/or the code received in the attach accept message(s) and/or the registration request message(s) to auto-dial emergency calls based on detected parameters associated with emergency characteristics.

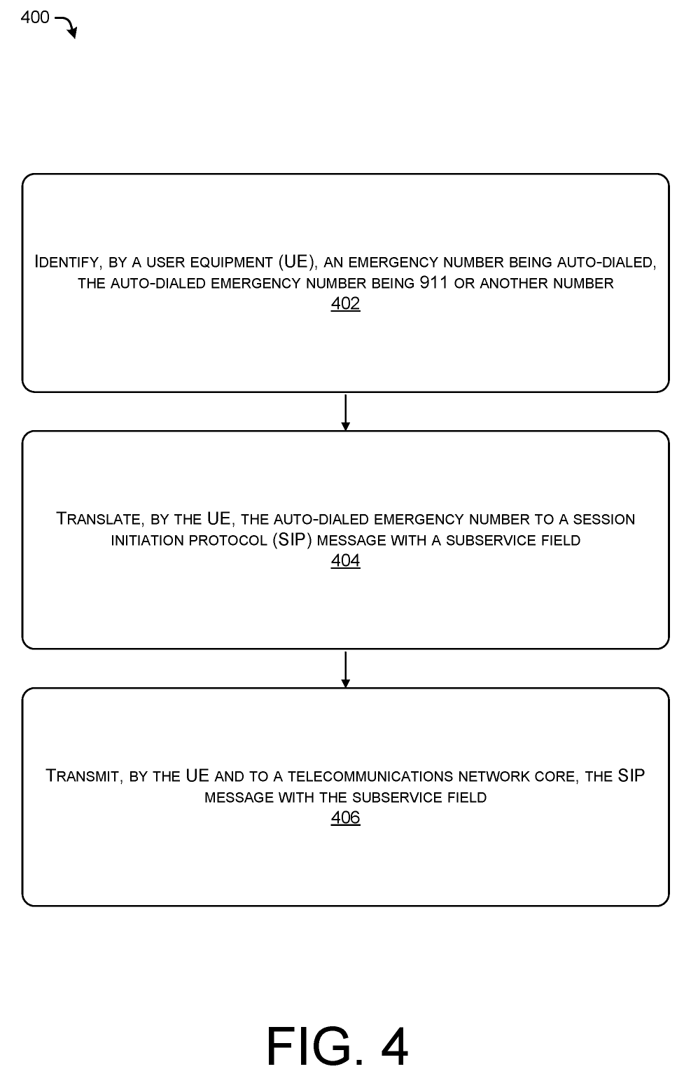

FIG. 4 illustrates an example process 400 for potential RRC UE population-based and predicted available spectrum-based future site capacity calculations and network management. The process 400 may be utilized for the calculation(s) to identify the average expected downlink speed(s), as discussed above with reference to FIGS. 1-3.

At operation 402, the process 400 can include identifying, by a user equipment (UE) 102, an emergency number being auto-dialed, the auto-dialed emergency number being 911 or another number. In some examples, the emergency number may be auto-dialed by the UE 102 based on the UE 102 detecting a parameter associated with a characteristic falls below or exceeds a threshold. In those or other examples, the parameter may be identified as being associated with the characteristic (e.g., an emergency characteristic) based on the parameter falling below or exceeding the threshold.

At operation 404, the process can include translating, by the UE 102, the auto-dialed emergency number to a session initiation protocol (SIP) message with a subservice field. The UE 102 may translate the auto-dialed emergency number to the SIP message with the subservice field, in response to identifying the emergency number being auto-dialed.

At operation 406, the process can include transmitting, by the UE 102 and to a telecommunications core network, the SIP message with the subservice field. The SIP message can be transmitted by the core to the PSAP 116. The PSAP 116 can perform various operations utilized by PSAP operators to route the call to the appropriate destination.

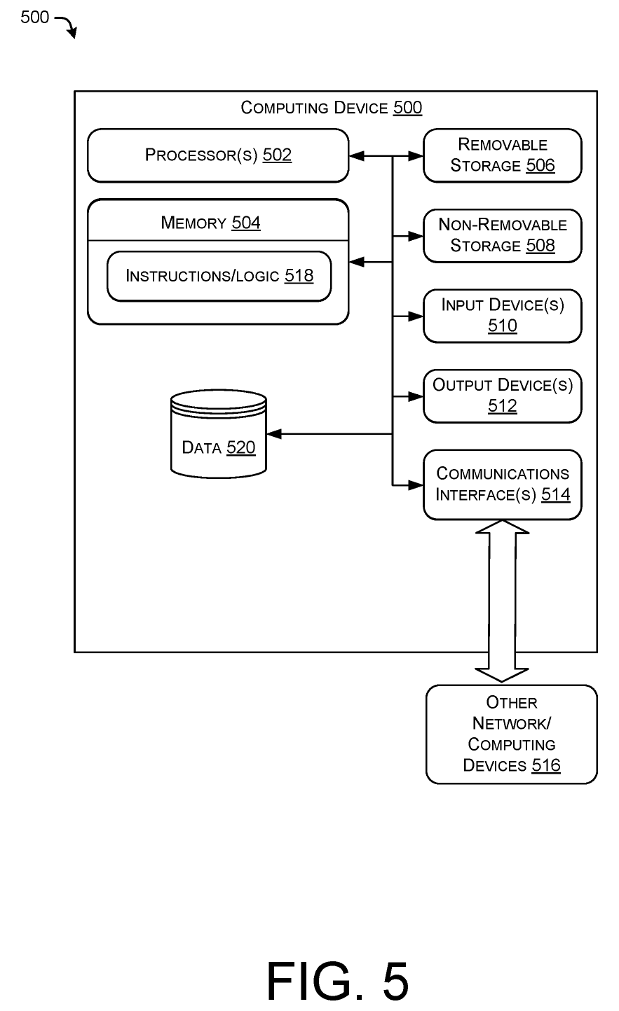

FIG. 5 illustrates is a block diagram of a server computer 500 architecture, in accordance with some examples of the present disclosure. The server computer 500 may be representative of an individual server (e.g., a server of the environment 100, such as any of the network coordination servers, any of the network management servers, etc., as discussed above with reference to FIG. 1) associated with the cellular network.

As shown, the server computer 500 may include one or more processors 502 and one or more forms of computer-readable memory 504. The server computer 500 may also include additional storage devices. Such additional storage may include removable storage 506 and/or non-removable storage 508.

The server computer 500 may further include input devices 510 (e.g., a touch screen, keypad, keyboard, mouse, pointer, microphone, etc.) and output devices 512 (e.g., a display, printer, speaker, etc.) communicatively coupled to the processor(s) 502 and the computer-readable memory 504. The server computer 500 may further include communications interface(s) 514 that allow the server computer 500 to communicate with other computing devices 516 (e.g., other nodes, a UE(s), etc.) such as via a network. The communications interface(s) 514 may facilitate transmitting and receiving wired and/or wireless signals over any suitable communications/data technology, standard, or protocol, as described herein.

In various embodiments, the computer-readable memory 504 comprises non-transitory computer-readable memory 504 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 504 may also be described as computer storage media and may include volatile and nonvolatile, removable and non-removable media implemented in any method or technology for storage of information, such as computer readable instructions, data structures, program modules, or other data. Computer-readable memory 504, removable storage 506 and non-removable storage 508 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server computer 500. Any such computer-readable storage media may be part of the server computer 500.

The memory 504 can include logic 518 (i.e., computer-executable instructions that, when executed, by the processor(s) 502, perform the various acts and/or processes disclosed herein) to implement synchronization of subscriber data, according to various examples as discussed herein. For example, the logic 518 is configured to carry out signaling and/or communications associated with the UE(s) 102 and/or 104. The memory 504 can further be used to store data 520, which may be used to implement synchronization of subscriber data, as discussed herein. In one example, the data 520 may include network information (e.g., the parameter(s), the calculate result(s), data utilized for the action(s), any other data associate with the environment 100, as discussed above with reference to FIG. 1).

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the software storage and execution configurations described above can be varied in many different ways. Thus, software implementing the techniques described above can be distributed on various types of computer-readable media, not limited to the forms of memory that are specifically described.

What is claimed is:

1. A system comprising:
at least one processor; and
non-transitory memory storing instructions that, when executed by the at least one processor, cause the at least one processor to perform operations comprising:
detecting, by a user equipment (UE), a parameter associated with a characteristic of a user or the UE;
identifying, by the UE, that the parameter is indicative of an emergency detected by the UE;
initiating, by the UE, an emergency call by dialing a number, the number including a primary emergency number or another number;
translating, by the UE, the number dialed to a session initiation protocol (SIP) message with a subservice field; and
transmitting, by the UE and to a node of a telecommunications core network, the SIP message with the subservice field.

2. The system of claim 1, the operations further comprising:
identifying that the number was automatically dialed by the UE,
wherein the translating of the number comprises:
in response to the identifying that the number was automatically dialed by the UE, translating the number dialed to the SIP message with the subservice field.

3. The system of claim 1, the operations further comprising:
determining that the number is automatically dialed by the UE instead of manually dialed by a user; and
in response to the determining that the number is automatically dialed by the UE, determining to generate and send the subservice field with an SOS INVITE message, as the SIP message.

4. The system of claim 1, the operations further comprising:
identifying that the user did not dial the number; and
in response to the detecting that the parameter falls below or exceeds a threshold or the identifying that the user did not dial the number, determining the number as being automatically dialed by the UE.

5. The system of claim 1, wherein the number includes, as the primary emergency number, 911, and
wherein initiating the emergency call comprises initiating, by the UE, the emergency call by dialing 911.

6. The system of claim 1, wherein the number includes the other number than the primary emergency number, and
wherein initiating the emergency call comprises initiating, by the UE, the emergency call by dialing the other number, the other number corresponding to a type of the UE.

7. The system of claim 1, wherein the number includes the other number than the primary emergency number, and a type of the subservice field corresponds to a value of the other number, and
wherein transmitting the SIP message comprises:
transmitting, by the UE and to the node, the SIP message with the subservice field, the node forwarding the subservice field to a public-safety access point (PSAP), the type of the subservice field identifying, to the PSAP, a type of the UE.

8. The system of claim 1, wherein the subservice field has a value of autotrigger.

9. The system of claim 1, wherein:
the number includes the other number than the primary emergency number,
a value of the subservice field corresponds to a value of the other number; and
the value of the subservice field includes autotriggerbysmartphone, autotriggerbywatch, or auttriggerbyvehicle.

10. A network element, comprising:
one or more processors; and
non-transitory memory storing computer-executable instructions that, when executed by the one or more processors, cause the one or more processors to perform operations comprising:
identifying, by a user equipment (UE), an emergency number being auto-dialed, the auto-dialed emergency number being a primary emergency number or another number;
translating, by the UE, the auto-dialed emergency number to a session initiation protocol (SIP) message with a subservice field; and
transmitting, by the UE and to a telecommunications core network, the SIP message with the subservice field.

11. The network element of claim 10, the operations further comprising:
identifying that the number was automatically dialed by the UE,
wherein the translating of the number comprises:
in response to the identifying that the number was automatically dialed by the UE, translating the number dialed to the SIP message with the subservice field.

12. The network element of claim 10, the operations further comprising:
determining that the number is automatically dialed by the UE instead of manually dialed by a user; and
in response to the determining that the number is automatically dialed by the UE, determining to generate and send the subservice field with an SOS INVITE message, as the SIP message.

13. The network element of claim 10, the operations further comprising:
in response to detecting that a parameter associated with the UE falls below or exceeds a threshold or identifying that a user did not dial the number, determining that the number is automatically dialed by the UE.

14. The network element of claim 10, wherein the number includes, as the primary emergency number, 911, the operations further comprising:
prior to the identifying of the number, initiating an emergency call by dialing 911.

15. The network element of claim 10, wherein the number includes, as the primary emergency number, 911, the operations further comprising:
prior to the identifying of the number, initiating, by the UE, an emergency call by dialing the other number, the other number corresponding to a type of the UE.

16. The network element of claim 10, wherein the number includes the other number than the primary emergency number , and a type of the subservice field corresponds to a value of the other number, and
wherein transmitting the SIP message comprises:
transmitting, by the UE and to a node of the telecommunications core network, the SIP message with the subservice field, the node forwarding the subservice field to a public-safety access point (PSAP), the type of the subservice field identifying, to the PSAP, a type of the UE.

17. A method comprising:
identifying, by a user equipment (UE), an emergency number being auto-dialed, the emergency number being a primary emergency number or another number;
translating, by the UE, the auto-dialed emergency number to a session initiation protocol (SIP) message with a subservice field; and
transmitting, by the UE and to a telecommunications core network, the SIP message with the subservice field.

18. The method of claim 17, further comprising:
identifying that the number was automatically dialed by the UE,
wherein the translating of the number comprises:
in response to the identifying that the number was automatically dialed by the UE, translating the number dialed to the SIP message with the subservice field.

19. The method of claim 17, further comprising:
determining that the number is automatically dialed by the UE instead of manually dialed by a user; and
in response to the determining that the number is automatically dialed by the UE, determining to generate and send the subservice field with an SOS INVITE message, as the SIP message.

20. The method of claim 17, further comprising:
in response to detecting that a parameter associated with the UE falls below or exceeds a threshold or identifying that a user did not dial the number, determining that the number is automatically dialed by the UE.
